(19) United States
(12) Patent Application Publication
(10) Pub. No.: US 2025/0158981 A1
(43) Pub. Date: May 15, 2025

(54) IMPROVED GOSSIP-PROTOCOL-BASED METHOD, DEVICE, EQUIPMENT AND MEDIUM FOR INCENTIVIZING BLOCK PROPAGATION

(71) Applicant: Southeast University, Nanjing (CN)

(72) Inventors: Xintong LING, Nanjing (CN); Zhang LI, Nanjing (CN); Yuwei LE, Nanjing (CN); Jiaheng WANG, Nanjing (CN); Xiqi GAO, Nanjing (CN)

(21) Appl. No.: 19/022,585

(22) Filed: Jan. 15, 2025

Related U.S. Application Data
(63) Continuation of application No. PCT/CN2024/091856, filed on May 9, 2024.

(30) Foreign Application Priority Data
May 18, 2023 (CN) 2023105646777

(51) Int. Cl. H04L 9/40; H04L 67/104

(52) U.S. Cl. CPC H04L 63/083; H04L 67/104

(57) ABSTRACT

An improved gossip-protocol-based method, a device, a piece of equipment and a medium for incentivizing block propagation. By improving the Gossip protocol and embedding block propagation rewards, the block forwarding process is accelerated. The designed signature chain structure records the block forwarding path and ensures that the path information is not tampered with. By combining the signature chain structure with the block generation process, the rewards are ensured to be truly and reliably distributed. A block propagation reward distribution strategy is designed to prevent forwarding nodes from adding pseudonyms in the propagation path. Therefore, the method can reduce the blockchain stale rate and enhance the scalability and consensus performance of the blockchain by accelerating block propagation in the presence of selfish nodes, and addresses the problem that selfish nodes refuse to forward blocks to save communication consumptions in the current blockchain network.

### CROSS REFERENCE TO RELATED APPLICATIONS

This application is a Continuation of International Application No. PCT/CN2024/091856 filed on May 9, 2024, which claims priority to Chinese Patent Application No. 2023105646777 on filed May 18, 2023 under 35 U.S.C. § 119, the entire contents of all of which are hereby incorporated by reference.

### TECHNICAL FIELD

The present disclosure relates to the technical field of blockchain, and in particular relates to an improved gossip-protocol-based method, a device, a piece of equipment and a medium for incentivizing block propagation.

### BACKGROUND

Since the concept of Bitcoin was first proposed by Satoshi Nakamoto in 2008, blockchain technology can build a trustworthy data model among network nodes through encryption algorithm, consensus mechanism and chain-based storage structure. At present, blockchain technology has become popular rapidly because of the openness, transparency, immutability, and traceability, and has been widely used in various areas such as the Internet of Things (IoT) and wireless communications. The consensus process serves as the basis for a blockchain system. In the consensus process, the newly generated blocks need a large number of P2P nodes for block verification and propagation, which consumes a lot of resources. The speed at which blocks propagate in the network is crucial for the consensus process and the security of the blockchain. The long-tailed block propagation delay can result in more orphan blocks and forks and make the blockchain vulnerable to attack.

At present, the existing researches on accelerating block propagation in blockchain network can be summarized into three methods: optimizing routing selection, reducing block size, and adjusting the network topology.

The above researches do not take into account the existence of some selfish nodes in blockchain network that refuse to forward blocks to reduce communication consumption. In blockchain network, selfish nodes significantly influence the block propagation process, especially in scenarios such as wireless networks where there may be a large number of resource-constrained nodes. These selfish nodes may refuse to forward blocks to save power, directly delaying the block propagation in the network. Therefore, it calls for an efficient method to incentivize selfish nodes in blockchain network to participate in forwarding blocks, thereby accelerating block propagation and improving the performance of blockchain systems.

### SUMMARY

The present disclosure provides an improved gossip-protocol-based method, a device, a piece of equipment and a medium for incentivizing block propagation to solve the problems of selfish nodes in current blockchain networks refusing to propagate blocks to reduce communication consumption.

According to the first aspect of the present disclosure, the embodiments provide an improved gossip-protocol-based method for incentivizing block propagation, and the method includes the following steps.

An inv message is received from a block generation node by a first forwarding node, and identity information of the first forwarding node and getData information of the first forwarding node are sent to the block generation node by the first forwarding node after receiving the inv message. A hash value of a block and the identity information of the first forwarding node are signed by the block generation node through the block generation node's own secret key to obtain a first signature, the first signature and the block are sent to the first forwarding node by the block generation node, and the first forwarding node is served as a current forwarding node.

After the block is verified by the first forwarding node, the inv message is sent to a second forwarding node by the first forwarding node. Identity information of the second forwarding node and getData information of the second forwarding node are sent to the first forwarding node by the second forwarding node. The first signature and the identity information of the second forwarding node are signed by utilizing a secret key of the current forwarding node to obtain a second signature. The first signature, the second signature and the block are sent to the second forwarding node by the first forwarding node. The current forwarding node is converted into the second forwarding node, and the block is verified by the second forwarding node, and the block is continuously forwarded after the verification is passed.

A block is started to be generated by the current forwarding node when the block is forwarded by the current forwarding node. A signature chain is constructed by utilizing all the signatures received by the current forwarding node to record a block forwarding path in a case where the current forwarding node generates the next block. The signature chain and block propagation rewards of nodes in the signature chain are embedded into the next block, and the next block is further diffused.

Optionally, in one embodiment of the present disclosure, the block propagation rewards of the nodes in the signature chain include block propagation rewards of all nodes in the signature chain.

Optionally, in one embodiment of the present disclosure, for intermediate forwarding nodes, the signature chain is constructed by signing identity information of a next hop node and signature information generated by a previous hop node by using its own key of the current intermediate forwarding node.

According to the second aspect of the present disclosure, the embodiments provide an improved gossip-protocol-based device for incentivizing block propagation, and the device includes the followings.

A receiving module is configured to receive an inv message from a block generation node, send identity information of a first forwarding node and getData information of the first forwarding node to the block generation node after receiving the inv message, to sign a hash value of a block and the identity information of the first forwarding node by the block generation node by using the block generation node's own secret key to obtain a first signature, and send the first signature and the block to the first forwarding node, wherein the first forwarding node is served as a current forwarding node.

A forwarding module is configured to verify the block, send the inv message to a next forwarding node in a case where the verification is passed, to send identity information of the next forwarding node and getData information of the next forwarding node to the current forwarding node by the next forwarding node, sign the first signature and the identity information of the next forwarding node by utilizing a secret key of the current forwarding node to obtain a second signature, send the first signature, the second signature and the block to the second forwarding node to convert the second forwarding node into the current forwarding node to verify the block, and continuously forward the block after the verification is passed.

A block generating module is configured to start to generate a next block when the block is forwarded by the current forwarding node, construct a signature chain by utilizing all the signatures received by the current forwarding node to record a block forwarding path when the next block is generated, embed the signature chain and block propagation rewards of nodes in the signature chain into a next block, and forward the next block.

Optionally, in one embodiment of the present disclosure, the block propagation rewards of the nodes in the signature chain include block propagation rewards of all nodes in the signature chain.

Optionally, in one embodiment of the present disclosure, for intermediate forwarding nodes, the signature chain is constructed by signing identity information of a next hop node and signature information generated by a previous hop node by using its own key of the current intermediate forwarding node.

According to the third aspect of the present disclosure, the embodiments provide a piece of electronic equipment. The equipment includes a memory, a processor, and a computer program that is stored on the memory and is capable of running on the processor, the processor executes the computer program to implement the method for the improved gossip protocol for the incentivizing block propagation as mentioned in the above embodiments.

According to the fourth aspect of the present disclosure, the embodiments provide a computer readable-storage medium, storing a computer program. The computer program is executed by the processor to implement the method for the improved gossip protocol for the incentivizing block propagation as mentioned in the above embodiments.

An improved gossip-protocol-based method, a device, a piece of equipment and a medium for incentivizing block propagation provided in the embodiments of the present disclosure have the following beneficial effects.
(1) In comparison with traditional blockchain networks, the present disclosure significantly reduces the occurrence of selfish nodes refusing to forward blocks in blockchain networks, significantly reduces the block propagation delay across network, accelerates block forwarding, and reduces the stale rate of blockchain, thereby improving the security of blockchain.
(2) The present disclosure can fully record the forwarding path of blocks and prevent it from being tampered with by utilizing a designed signature chain structure to ensure the integrity of block forwarding path information, combine the signature chain structure closely with the block generation process to ensure the reliability of the reward distribution process.
(3) The present disclosure has a certain network effect, and the designed reward distribution strategy cannot merely encourage nodes to forward blocks, but also encourage more nodes to participate in the blockchain network. With the continuous expansions of the network scales, more nodes will join the network, especially for nodes in the blockchain network that cannot participate in the block generation process and have limited resources, they can participate in the blockchain network by forwarding blocks, thereby further accelerating the propagation of blocks and forming positive feedback.
(4) The present disclosure improves the Gossip protocol by adding merely a small amount of transmission overhead to the interaction process of the Gossip protocol, without making any modifications to the necessary fields of the Gossip protocol, which is compatible and is easy to be implemented.

Additional aspects and advantages of the present disclosure will be partially described in the following descriptions, some of which will become apparent from the following descriptions, or can be learned through the practices of the present disclosure.

### BRIEF DESCRIPTION OF THE DRAWINGS

The above and/or additional aspects and advantages of the present disclosure will become apparent and easily to be understood from the following descriptions of embodiments in conjunction with the accompanying drawings.

FIG. 1 illustrates a flowchart diagram of an improved gossip-protocol-based method for incentivizing block propagation provided by an embodiment of the present disclosure.

FIG. 2 illustrates a schematic structural diagram of the signature chain for recording block forwarding paths in the improved gossip protocol provided by an embodiment of the present disclosure.

FIG. 3 illustrates a schematic structural diagram of a block with an embedded signature chain provided by an embodiment of the present disclosure.

FIG. 4 illustrates a schematic diagram of the block propagation delay before and after the introduction of the present disclosure in the case where selfish nodes exist in a blockchain network.

FIG. 5 illustrates a schematic diagram of the blockchain stale rate before and after the introduction of the present disclosure in the case where selfish nodes exist in the blockchain network.

FIG. 6 illustrates a schematic diagram of the throughput of the blockchain network before and after the introduction of the present disclosure in the case where selfish nodes exist in network.

FIG. 7 illustrates an example diagram of an improved gossip-protocol-based device for incentivizing block propagation provided by an embodiment of the present disclosure.

FIG. 8 illustrates a schematic structure diagram of a piece of electronic equipment provided by an embodiment of the present disclosure.

### DETAILED DESCRIPTIONS

The embodiments of the present disclosure are clarified in detail below, and examples of the embodiments are illustrated in the accompanying drawings, where the same or similar reference numerals throughout represent the same or similar elements or components with the same or similar functions. The embodiments described below with reference to the accompanying drawings are exemplary and intended to explain the present disclosure, and should not be construed as the limit to the present disclosure.

An improved gossip-protocol-based method, a device, a piece of equipment and a medium for incentivizing block propagation in the embodiments of the present disclosure are described below with reference to the accompanying drawings. In view of the problems of selfish nodes refusing to forward blocks in order to save resources in the current blockchain network mentioned in the background technology, the present disclosure provides an improved gossip-protocol-based method for incentivizing block propagation. The method embeds the block propagation rewards to accelerate the block forwarding process and records the block forwarding paths through a signature chain structure to prevent path information from being tampered with. The block structure with an embedded signature chain ensures the reliability of the reward distribution process. A block propagation reward distribution strategy is designed to prevent forwarding nodes from adding virtual identities in the forwarding path, thus incentivizing selfish nodes in the blockchain network to forward blocks and accelerating block propagation in the blockchain network. This effectively improves the performance of the blockchain system.

In one embodiment, an improved gossip-protocol-based method for incentivizing block propagation is provided in the present disclosure, which includes the following steps.

An inv message is received from a block generation node by a first forwarding node, and identity information of the first forwarding node and getData information of the first forwarding node are sent to the block generation node by the first forwarding node after receiving the inv message. A hash value of a block and the identity information of the first forwarding node are signed by the block generation node through the block generation node's own secret key to obtain a first signature, the first signature and the block are sent to the first forwarding node by the block generation node, and the first forwarding node is served as a current forwarding node.

After the block is verified by the first forwarding node, the inv message is sent to a second forwarding node by the first forwarding node. Identity information of the second forwarding node and getData information of the second forwarding node are sent to the first forwarding node by the second forwarding node. The first signature and the identity information of the second forwarding node are signed by utilizing a secret key of the current forwarding node to obtain a second signature. The first signature, the second signature and the block are sent to the second forwarding node by the first forwarding node. The current forwarding node is converted into the second forwarding node, and the block is verified by the second forwarding node, and the block is continuously forwarded after the verification is passed.

A block is started to be generated by the current forwarding node when the block is forwarded by the current forwarding node. A signature chain is constructed by utilizing all the signatures received by the current forwarding node to record a block forwarding path in the case where the current forwarding node generates the next block. The signature chain and block propagation rewards of nodes in the signature chain are embedded into the next block, and the next block is further diffused.

In one embodiment, an improved gossip-protocol-based device for incentivizing block propagation is provided in the present disclosure, which includes the following modules.

A receiving module is configured to receive an inv message from a block generation node, send identity information of a first forwarding node and getData information of the first forwarding node to the block generation node after receiving the inv message, to sign a hash value of a block and the identity information of the first forwarding node by the block generation node by using the block generation node's own secret key to obtain a first signature, and send the first signature and the block to the first forwarding node, wherein the first forwarding node is served as a current forwarding node.

A forwarding module is configured to verify the block, send the inv message to a next forwarding node in the case where the verification is passed, to send identity information of the next forwarding node and getData information of the next forwarding node to the current forwarding node by the next forwarding node, sign the first signature and the identity information of the next forwarding node by utilizing a secret key of the current forwarding node to obtain a second signature, send the first signature, the second signature and the block to the second forwarding node to convert the second forwarding node into the current forwarding node to verify the block, and continuously forward the block after the verification is passed.

A block generating module is configured to start to generate a next block when the block is forwarded by the current forwarding node, construct a signature chain by utilizing all the signatures received by the current forwarding node to record a block forwarding path when the next block is generated, embed the signature chain and block propagation rewards of nodes in the signature chain into a next block, and forward the next block.

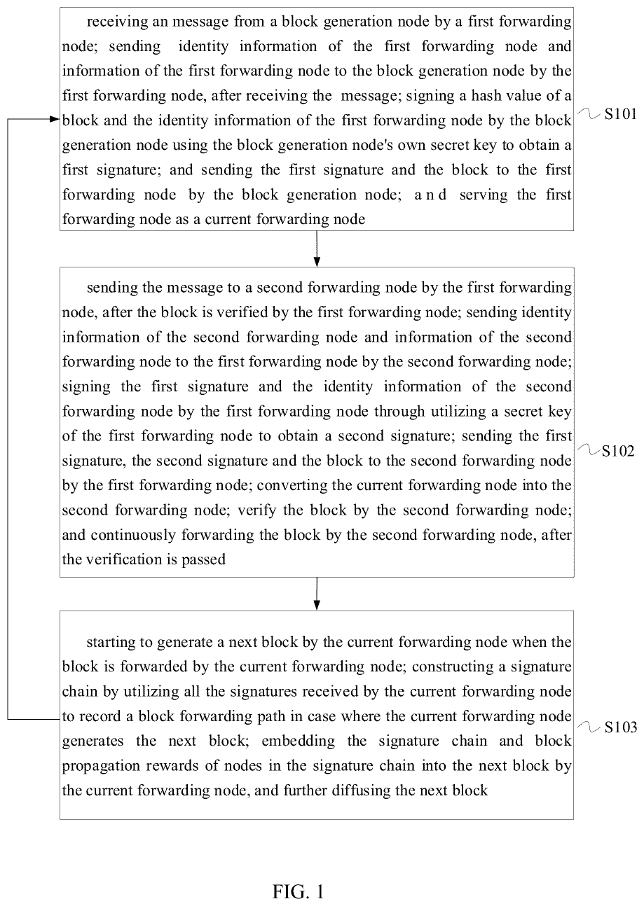

Specifically, FIG. 1 illustrates a flowchart diagram of an improved gossip-protocol-based method for incentivizing block propagation provided in an embodiment of the present disclosure.

As illustrated in FIG. 1, provided is an improved gossip-protocol-based method for incentivizing block propagation, and the method includes the following steps.
In Step S101, An inv message is received from a block generation node by a first forwarding node, and identity information of the first forwarding node and getData information of the first forwarding node are sent to the block generation node by the first forwarding node after receiving the inv message. A hash value of a block and the identity information of the first forwarding node are signed by the block generation node through the block generation node's own secret key to obtain a first signature, and the first signature and the block are sent to the first forwarding node by the block generation node, and the first forwarding node is served as a current forwarding node.

In the embodiments of the present disclosure, after the block is generated by the block generation node, the inv message is sent to the first forwarding node. After the first forwarding node receives the inv message from the block generation node, the first forwarding node requests the block from the block generation node and sends the identity information of the first forwarding node and the getData information to the block generation node.

After the block generation node receives the identity information and getData information from the first forwarding node, the block generation node signs the hash value of the generated block and the identity information of the first forwarding node with the secret key, and sends the signature and the block to the first forwarding node.
In Step S102, after the block is verified by the first forwarding node, the inv message is sent to a second forwarding node by the first forwarding node. Identity information of the second forwarding node and getData information of the second forwarding node are sent to the first forwarding node by the second forwarding node. The first signature and the identity information of the second forwarding node are signed by utilizing a secret key of the current forwarding node to obtain a second signature. The first signature, the second signature and the block are sent to the second forwarding node by the first forwarding node. The current forwarding node is converted into the second forwarding node, and the block is verified by the second forwarding node, and the block is continuously forwarded after the verification is passed.

In the embodiments of the present disclosure, the first forwarding node verifies the block from the block generation node. It should be noted that the method for verifying the blocks in the embodiments of the present disclosure can use the existing verification methods. For example, verifying whether the payload data in the block to be forwarded contains conflicting data, then verifying whether the block header satisfies the protocol requirements, and eventually determining whether the hash value of the entire block satisfies the difficulty level. The above is merely an example and the specific implementations are not limited.

After each of the intermediate forwarding nodes successfully verifies the block to be forwarded, the forwarding process of the above embodiment is repeated to send the block to the next forwarding node.

It should be noted that in the embodiments of the present disclosure, after receiving the identity information and getData information from the second forwarding node, the first forwarding node uses the first forwarding node's own secret key to sign the signature from the block generation node and the identity information of the second forwarding node, and sends all signatures and the block to the second forwarding node. The second node verifies the received block and continues forwarding the received block after passing the verification.
In Step S103, a next block is started to be generated by the current forwarding node when the block is forwarded by the current forwarding node, a signature chain is constructed by utilizing all the signatures received by the current forwarding node to record a block forwarding path in the case where the current forwarding node generates the next block. The signature chain and block propagation rewards of nodes in the signature chain are embedded into the next block by the current forwarding node, and the next block is further diffused.

In the embodiments of the present disclosure, the current forwarding node begins to generate the next block, when the current forwarding node forwards the block to be forwarded. In the case where the next block is generated, the forwarding node constructs a signature chain based on all the received signature information, embeds the signature chain into the next block, and distributes block propagation rewards to all nodes on the signature chain.

It can be understood that the next block generated by the node must include the signature chain and the block propagation reward distributed for the nodes on the signature chain. The block propagation rewards of the nodes in the signature chain include block propagation rewards of all nodes in the signature chain.

For the intermediate forwarding nodes, the signature chain that records the forwarding path information is constructed by singing the combination of the identity information of the next hop node and the signature information generated by the previous hop node by using the current intermediate forwarding node secret key. The path information of block forwarding is recorded by this means.

A signature chain that records the forwarding path information of the previous block, as well as a block propagation reward field distributed to all nodes on the signature chain are added to the block structure embedded with a signature chain. The path information contained in the signature chain must be traceable to the generating node of the previous block, and merely the block containing all the above contents is considered to be valid.

The block propagation reward distribution strategy refers to the rules followed when distributing rewards to the forwarding nodes that assist in forwarding blocks. Specifically, forwarding nodes obtain additional identities through forgery without increasing the rewards they obtain. According to the principles followed by the block propagation reward distribution strategy, two strategies are included, that is, the first is a uniform reward distribution strategy, where all forwarding nodes on the forwarding path ultimately obtain the same reward; whereas the second is a proportional reward distribution strategy, where the reward relation between adjacent forwarding nodes on the forwarding path is that the ratio of the reward obtained by the next forwarding node to the reward obtained by the previous forwarding node is a constant less than 1, which is called as the proportional factor. Reward distribution is implemented by using signatures in the signature chain as credentials and automatically completes when the next block is generated.

The improved gossip-protocol-based method for incentivizing block propagation of the present disclosure is specifically clarified below in combination with one specific embodiment.

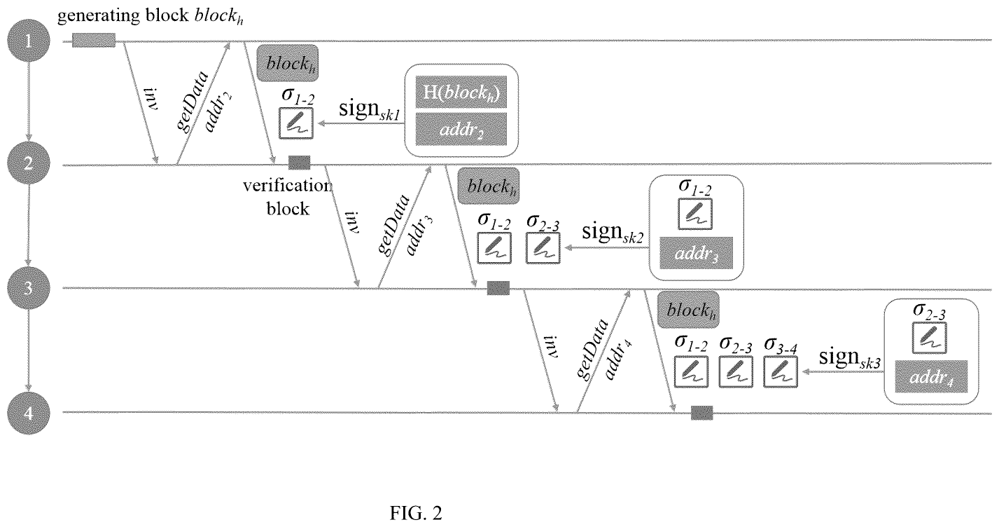

As illustrated in FIG. 2, the block forwarding process of four nodes is presented, including the following steps.
(1) After the node 1 generates the block h, the inv message is sent to the node 2.
(2) After the node 2 receives the inv message from the node 1, the node 2 requests the block h from node 1 and sends the identity of the node 2 and the getData information to the node 1.
(3) After the node 1 receives the identity information addr₂ of the node 2 and getData information from the node 2, the node 1 uses the own secret key sk1 of the node 1 to perform a sign operation signₛₖ₁ on the hash value H (blockₕ) of the block h and the identity information of the node 2, and sends the signature σ₁₋₂ and the block h to the node 2.
(4) The node 2 verifies the block h from the node 1, and after successful verification, the node 2 forwards the block h. The node 2 repeats Steps (1) to (2) to the node 3, that is, the node 2 sends the inv message to the node 3. After receiving the inv message from the node 2, node 3 requests the block h from the node 2 and sends the identity information addr₃ of the node 3 and getData information to node 2. The difference is that in Step (3), after the node 2 receives the identity information addr₃ of the node 3 and getData information from the node 3, the node 2 uses the own secret key sk2 of the node 2 to sign the signature σ₁₋₂ from the node 1 and the identity information addr₃ of the node 3, and sends the generated signature σ₂₋₃, the signature σ₁₋₂ from the node 1, and the block h together to the node 3, and continues executing Step (4).
(5) Taking the node 4 as an example, when the node 4 verifies the received block h and the verification is passed, the node 4 forwards the block h and the node 4 generates the next block h+1. At the same time, according to all the received signature information σ₁₋₂, σ₂₋₃ and σ₃₋₄, the node 4 constructs a signature chain, and embeds the signature chain into the generated next block h+1, and allocates block propagation rewards to all nodes (that is, the node 1, the node 2, the node 3 and the node 4) included in the signature chain.

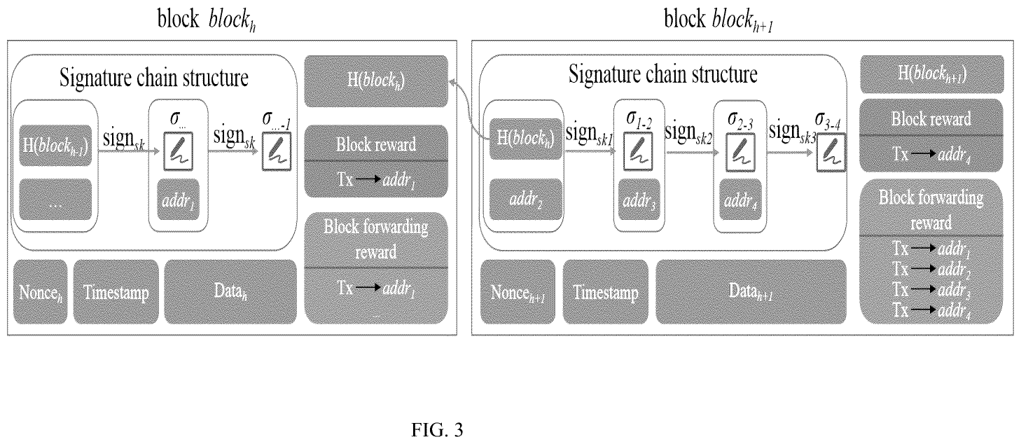

As illustrated in FIG. 3, the structure of the block h+1 embedded with the signature chain of the present disclosure includes a signature chain that records the forwarding path information of four nodes, the hash value H (blockₕ₊₁) of the block h+1, the block reward assigned to node 4 that generates the block h+1, the block propagation reward given to the four forwarding nodes, the random number Nonceₕ₊₁, generation timestamps, and other transaction data.

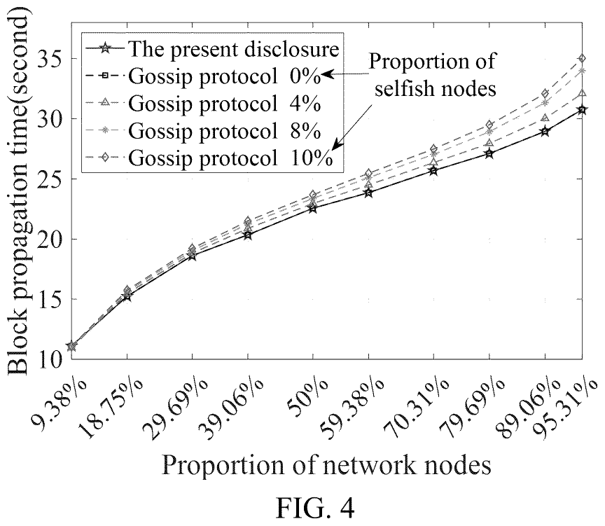

With reference to FIGS. 4 to 6, in order to reveal the performance of the present disclosure in practical work, actual testing and data recording are conducted for the typical embodiments of the present disclosure, and the analysis results are as follows.

FIG. 4 reflects that in the case where selfish nodes exist in the blockchain network, the impacts on the block propagation delay before and after the introduction of the present disclosure. The block propagation time refers to the difference value between the time when a node receives a block and the timestamp when the block is generated. The distributions of computing power among nodes in the network are uniform. In the Gossip protocol, the block propagation time increases significantly with the increase of the proportion of the selfish nodes in the network, which further indicates that the behavior of selfish nodes refusing to forward blocks has a negative impact on the performance of the blockchain network. In the case where no selfish nodes exist in the network, since the costs of signature and identity are negligible by being compared with the block size, the present disclosure is consistent with the block propagation time of the Gossip protocol. In the case where a block reaches the same percentage of network nodes, the block propagation time of the present disclosure is shorter than that of the Gossip protocol. Therefore, in the presence of selfish nodes, the present disclosure can reduce the block propagation time and accelerate the forwarding speed of block.

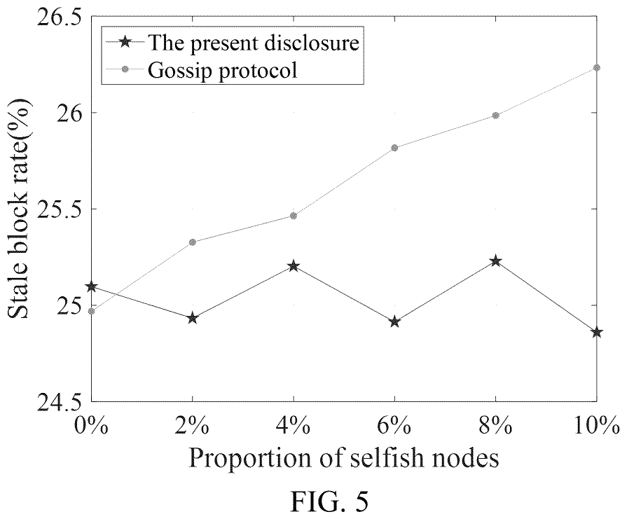

FIG. 5 reflects the changes in blockchain stale rate before and after the introduction of the present disclosure when selfish nodes exist in the blockchain network. It can be seen that in the Gossip protocol, the blockchain stale rate increases significantly with the increase of the proportion of selfish nodes in the network. After introducing the present disclosure, the impacts of selfish nodes on the blockchain stale rate can be significantly improved, thereby enhancing the security of the blockchain system.

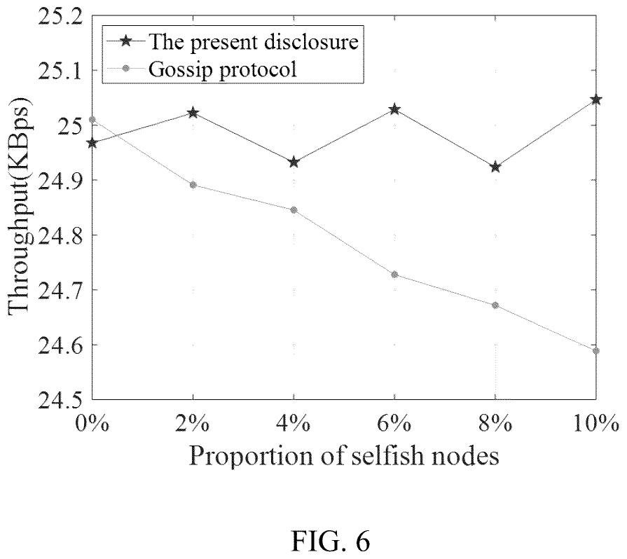

FIG. 6 reflects the changes in throughput of the blockchain network before and after the introduction of the present disclosure when selfish nodes exist in the blockchain network. Throughput reflects the ability of blockchain to process transactions, which is crucial for the security and scalability of blockchain. It can be seen that in the Gossip protocol, the throughput gradually decreases as the proportion of selfish nodes in the network increases. After introducing the present disclosure, high throughput can be maintained by accelerating block forwarding and promoting consensus process in the presence of selfish nodes, which can effectively alleviate the throughput decline caused by selfish nodes and improve the security of the blockchain.

According to the method for an improved gossip-protocol-based method for incentivizing block propagation in the embodiments of the present disclosure, block propagation rewards are embedded through the improved gossip protocol to accelerate the block forwarding process. The designed signature chain structure records block forwarding paths and prevent path information from being tampered with. The blockchain structure is embedded with the signature chain, and the reliability of the reward distribution process is ensured. The designed block propagation reward distribution strategy prevents forwarding nodes from adding pseudonyms in the forwarding path. Therefore, the method of the present disclosure can motivate selfish nodes in the blockchain network to forward blocks and accelerate block propagation in the blockchain network, effectively improving the performance of the blockchain system.

Next, an improved gossip-protocol-based device for incentivizing block propagation proposed according to embodiments of the present disclosure is clarified with reference to the accompanying drawings.

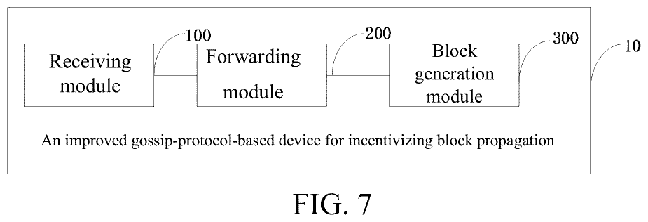

FIG. 7 illustrates an example diagram of the improved gossip-protocol-based device for incentivizing block propagation according to an embodiment of the present disclosure.

As illustrated in FIG. 7, the improved gossip-protocol-based device for incentivizing block propagation includes a receiving module 100, a forwarding module 200, and a block generation module 300.

A receiving module 100 is configured to receive an inv message from a block generation node, and send identity information of a current forwarding node and getData information of the current forwarding node to the block generation node after receiving the inv message, to sign a hash value of a block and the identity information of the current forwarding node by the block generation node using the block generation node's own secret key, and obtain a first signature; send the first signature and the block to the current forwarding node.

A forwarding module 200 is configured to verify the block; send the inv message to a next forwarding node in the case where a verification is passed, to send identity information of the next forwarding node and getData information of the next forwarding node to the current forwarding node by the next forwarding node; sign the first signature and the identity information of the next forwarding node by utilizing a secret key of the current forwarding node to obtain a second signature; send the first signature, the second signature and the block to the next forwarding node, to take the next forwarding node as the current forwarding node to verify the block; continuously forward the block after the verification is passed.

A block generating module 300 is configured to start to generate a next block when the block is forwarded by the current forwarding node, construct a signature chain by utilizing all the signatures received by the current forwarding node to record a block forwarding path, in the case where the current forwarding node generates the next block, embed the signature chain and block propagation rewards of nodes in the signature chain into a next block, and forward the next block.

Optionally, in one embodiment of the present disclosure, the block propagation rewards of the nodes in the signature chain include block propagation rewards of all nodes in the signature chain.

Optionally, in one embodiment of the present disclosure, for intermediate forwarding nodes, the signature chain is constructed by signing identity information of a next hop node and signature information generated by a previous hop node by using an own key of the current forwarding node.

It should be noted that the above explanation and the specification of the improved gossip-protocol-based method for incentivizing block propagation also applies to the improved gossip-protocol-based device for incentivizing block propagation in this embodiment, and will not be described in detail herein.

According to the improved gossip-protocol-based device for incentivizing block propagation proposed in the embodiments of the present disclosure, block propagation rewards are embedded through the improved Gossip protocol to accelerate the block forwarding process. The designed signature chain structure records block forwarding paths and prevent path information from being tampered with. By the blockchain structure embedded with the signature chain, the reliability of the reward distribution process is ensured. The designed block propagation reward distribution strategy prevents forwarding nodes from adding false identities in the forwarding path. Therefore, the method of the present disclosure can motivate selfish nodes in the blockchain network to forward blocks and accelerate block propagation in the blockchain network, effectively improving the performance of the blockchain system.

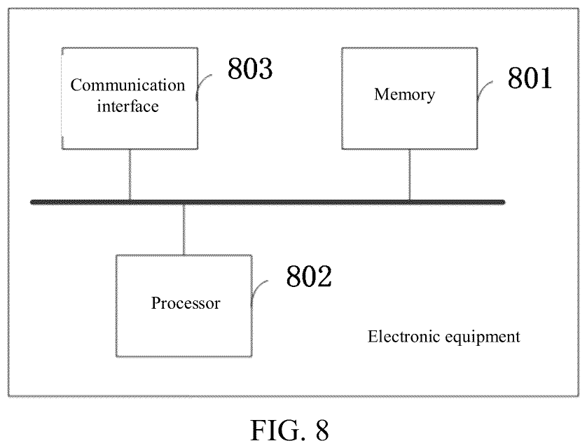

FIG. 8 illustrates a schematic structure diagram of a piece of electronic equipment provided in an embodiment of the present disclosure. The electronic equipment may include the followings.

A memory 801, a processor 802, and a computer program that is stored on the memory 801 and is capable of running on the processor 802.

The processor 802 executes the computer program to implement an improved gossip-protocol-based method for incentivizing block propagation as mentioned in the above embodiments.

Further, the electronic equipment further includes the followings.

Communication interface 803 is configured to communicate between the memory 801 and the processor 802.

Memory 801 is configured to store the computer programs that can run on processor 802.

Memory 801 may include a high-speed RAM memory, as well as a non-volatile memory, such as at least one disk storage.

If the memory 801, processor 802, and communication interface 803 are implemented independently, the communication interface 803, memory 801, and processor 802 can be connected to each other through a bus and communicate with each other. The bus can be an Industry Standard Architecture (ISA) bus, a Peripheral Component (PCI) bus, or an Extended Industry Standard Architecture (EISA) bus. Buses can be divided into address buses, data buses, control buses, and the like. For ease of representation, merely one thick line is represented in FIG. 8, which does not indicate that merely one bus or one type of bus exists.

Optionally, in a specific implementation, in the case where the memory 801, processor 802, and communication interface 803 are integrated on a single chip, the memory 801, processor 802, and communication interface 803 can communicate with each other through internal interfaces.

The processor 802 may be a Central Processing Unit (CPU), or an Application Specific Integrated Circuit (ASIC), or be configured to one or more integrated circuits that implement embodiments of the present disclosure.

The embodiments further provide a computer readable storage medium, which stores a computer program. When the computer program is executed by the processor, the computer program implements the above improved gossip-protocol-based method for incentivizing block propagation.

In the descriptions of the specification, the reference terms, such as “one embodiment”, “some embodiments”, “examples”, “specific examples”, or “some examples” mean that the specific features, structures, materials, or characteristics described in conjunction with the embodiments or examples are included in at least one embodiment or example of the present disclosure. In this specification, the schematic expressions of the above terms do not necessarily refer to the same embodiments or examples. Moreover, the specific features, structures, materials, or characteristics described can be combined in an arbitrary one or N embodiments or examples in an appropriate manner. Moreover, a person skilled in the art can combine and couple the different embodiments or examples described in this specification, as well as the features of different embodiments or examples, without conflicting with each other.

In addition, the terms “first” and “second” are merely used to describe purposes and cannot be understood as indicating or implying relative importance or implying the number of technical features indicated. Therefore, the features that are limited to “first” and “second” can explicitly or implicitly include at least one of these features. In the descriptions of the present disclosure, “N” means at least two, such as two, three, and the like, unless otherwise specified.

One process or method descriptions in a flowchart or otherwise described herein can be understood as representing a module, fragment, or portion of code including one or more executable instructions for implementing custom logic functions or processes, and the scope of the preferred embodiments of the present disclosure includes additional implementations, which may be performed in a substantially simultaneous manner or in reverse order based on the functions involved, without following the order shown or discussed, this should be understood by a person skilled in the art to which the embodiments of the present disclosure belong.

It should be understood that the each part of the present disclosure can be implemented by using hardware, software, firmware, or a combination thereof. In the above implementations, N steps or methods can be implemented by using software or firmware stored in memory and can be executed by a suitable instruction execution system. For example, in the case where the N steps or methods are implemented in hardware as in another implementation, an arbitrary one or a combination of the following techniques known in the art can be used, that is, discrete logic circuits with logic gate circuits for implementing logic functions on data signals, application specific integrated circuits with suitable combinational logic gate circuits, programmable gate arrays (PGA), field programmable gate arrays (FPGA), and the like.

Ordinary persons skilled in the art can understand that all or part of the steps carried by the method for implementing the above embodiments can be completed by instructing relevant hardware through a program. The program can be stored in a computer-readable storage medium, and in the case where the program is executed, one or a combination of the steps of the method embodiment are included.

1. An improved gossip-protocol-based method for incentivizing block propagation, wherein the method comprises the following steps:
receiving, by a first forwarding node, an inv message from a block generation node; sending, by the first forwarding node, identity information of the first forwarding node and getData information of the first forwarding node to the block generation node after receiving the inv message; signing, by the block generation node using the block generation node's own secret key, a hash value of a block and the identity information of the first forwarding node to obtain a first signature; and sending, by the block generation node, the first signature and the block to the first forwarding node; serving the first forwarding node as a current forwarding node; and
sending, by the first forwarding node, the inv message to a second forwarding node after the block is verified by the first forwarding node; sending, by the second forwarding node, identity information of the second forwarding node and getData information of the second forwarding node to the first forwarding node; signing, by the first forwarding node, the first signature and the identity information of the second forwarding node through utilizing a secret key of the first forwarding node to obtain a second signature; sending, by the first forwarding node, the first signature, the second signature and the block to the second forwarding node; converting the current forwarding node into the second forwarding node; verify, by the second forwarding node, the block; and continuously forwarding, by the second forwarding node, the block after the verification is passed,
wherein a next block is started to be generated by the current forwarding node when the block is forwarded by the current forwarding node, a signature chain is constructed by utilizing all the signatures received by the current forwarding node to record a block forwarding path in a case where the current forwarding node generates the next block, the signature chain and block propagation rewards of nodes in the signature chain are embedded into the next block, and the next block is further diffused.

2. The method according to claim 1, wherein the block propagation rewards of the nodes in the signature chain include block propagation rewards of all nodes in the signature chain.

3. The method according to claim 1, wherein for intermediate forwarding nodes, the signature chain is constructed by signing identity information of a next hop node and signature information generated by a previous hop node by using an own key of the current forwarding node.

4. An improved gossip-protocol-based device for incentivizing block propagation, wherein the device comprises:
a receiving module, configured to receive an inv message from a block generation node, send identity information of a first forwarding node and getData information of the current forwarding node to the block generation node after receiving the inv message, to sign a hash value of a block and the identity information of the first forwarding node by the block generation node using the block generation node's own secret key to obtain a first signature, and send the first signature and the block to the first forwarding node, wherein the first forwarding node is served as a current forwarding node;
a forwarding module, configured to verify the block, send the inv message to a next forwarding node in a case where a verification is passed, to send identity information of the next forwarding node and getData information of the next forwarding node to the current forwarding node by the next forwarding node, sign the first signature and the identity information of the next forwarding node by utilizing a secret key of the current forwarding node to obtain a second signature, send the first signature, the second signature and the block to the second forwarding node to convert the second forwarding node into the current forwarding node to verify the block, and continuously forward the block after the verification is passed; and
a block generating module, configured to start to generate a next block when the block is forwarded by the current forwarding node, construct a signature chain by utilizing all the signatures received by the current forwarding node to record a block forwarding path when the next block is generated, embed the signature chain and block propagation rewards of nodes in the signature chain into a next block, and forward the next block.

5. The device according to claim 4, wherein the block propagation rewards of the nodes in the signature chain include block propagation rewards of all nodes in the signature chain.

6. The device according to claim 4, wherein for intermediate forwarding nodes, the signature chain is constructed by signing identity information of a next hop node and signature information generated by a previous hop node by using an own key of the current forwarding node.

7. A piece of electronic equipment, wherein the equipment comprises a memory, a processor, and a computer program that is stored on the memory and is capable of running on the processor, the processor executes the computer program to implement the improved gossip-protocol-based method for incentivizing block propagation according to claim 1.

8. A computer readable storage medium, storing a computer program, wherein the computer program is executed by the processor to implement the method for the improved gossip-protocol-based method for incentivizing block propagation according to claim 1.
